(19) United States
(12) Patent Application Publication
(10) Pub. No.: US 2013/0000281 A1
(43) Pub. Date: Jan. 3, 2013

(54) DEF PUMP MOUNTED TO TANK

(75) Inventors: Jack A. Merchant, Peoria, IL (US); Stephan D. Roozenboom, Washington, IL (US)

(73) Assignee: Caterpillar Inc., Peoria, IL (US)

(21) Appl. No.: 13/173,315

(22) Filed: Jun. 30, 2011

(51) Int. Cl. F01N 3/24; B67D 7/06

(52) U.S. Cl. 60/295; 222/321.9

(57) ABSTRACT

A fluid supply assembly includes a tank configured for holding a fluid and a pump configured to draw the fluid from the tank, wherein the tank includes a recess and the pump is mounted to the tank in the recess. The pump may be connected to the tank along either, or both of, a first and/or a second surface of the recess, wherein the first surface and the second surface may be orthogonal to one another. The fluid supply assembly may further include a header disposed on a horizontal surface of the tank, the header may include at least a portion thereof which extends into an interior of the tank, wherein the pump may draw the fluid from the tank via the header.

### TECHNICAL FIELD

The present disclosure relates to engine exhaust aftertreatment systems and more particularly to a pump and tank unit used in providing a reductant to the exhaust aftertreatment systems.

### BACKGROUND

A selective catalytic reduction (SCR) system may be included in an exhaust treatment or aftertreatment system for a power system to remove or reduce nitrous oxide (NOx or NO) emissions coming from the exhaust of an engine. SCR systems use reductants, such as urea, that are introduced into the exhaust stream to significantly reduce the amount of nitrous oxides (NOx) in the exhaust.

The construction and installation of the SCR system can be a considerable component of the overall power system cost. Packaging of the SCR system is of particular concern given that most applications for power systems have a limited space requirement. That is, there is only so much space available within a machine, boat, generator housing, etc., in which the power system is installed to accommodate the engine and any required emissions solutions systems, such as the SCR system.

U.S. Pat. No. 7,895,829 (the '829 patent) discloses an aftertreatment system including an SCR system. The SCR system includes a urea solution tank. A urea solution pump is provided within the urea solution tank.

### SUMMARY

The present disclosure provides a fluid supply assembly including a tank configured for holding a fluid, and a pump configured to draw the fluid from the tank, wherein the tank includes a recess and the pump is mounted to the tank in the recess.

The present disclosure also provides an aftertreatment system that includes an exhaust conduit which transmits exhaust gases from an engine, a fluid supply assembly which introduces a fluid into the exhaust gases. The fluid supply assembly includes a tank configured for holding a fluid, a pump disposed in a recess and configured to draw the fluid from the tank, and an SCR catalyst which receives the exhaust and reductant. The tank includes a recess therein. The pump is supported on two separate sides by the recess and an SCR catalyst which receives the exhaust and reductant.

The present disclosure also provides a method of manufacturing a fluid supply assembly that includes providing a tank configured to hold the fluid, the tank having a recess, mounting a pump to the tank in the recess, and fluidly connecting the pump to an inside of the tank via a header.

### BRIEF DESCRIPTION OF THE DRAWINGS

FIG. 1 is a diagrammatic view of a machine including a power system with an engine and an aftertreatment system.

FIG. 2 is a diagrammatic view of the aftertreatment system including a reductant supply system including a pump electronics and tank unit (PETU) according to the present disclosure.

FIG. 3 is a left-side elevation view of a PETU according to the present disclosure.

FIG. 4 is a right-side elevation view of a PETU according to the present disclosure.

FIG. 5 is a top elevation view of a PETU according to the present disclosure.

### DETAILED DESCRIPTION

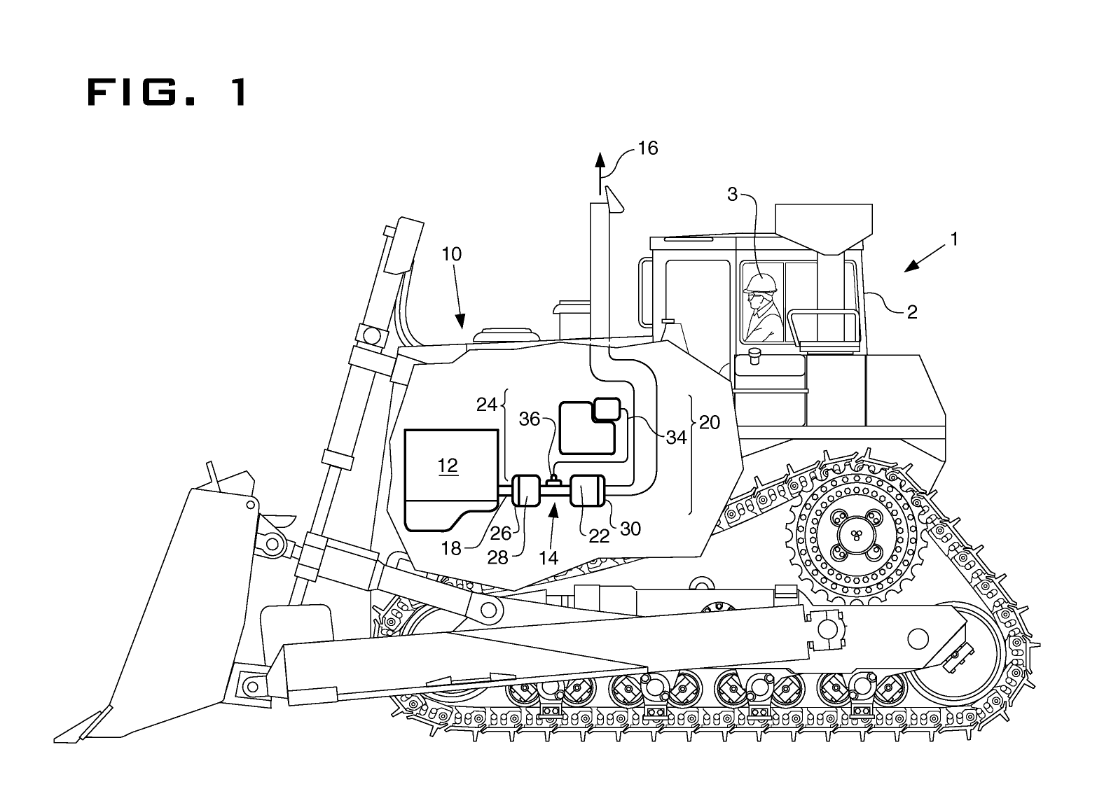

FIG. 1 is a diagrammatic view of a machine 1 including a cab 2 where an operator 3 sits and a power system 10. The machine 1 might be a track type tractor (as illustrated), on-highway truck, car, vehicle, off-highway truck, earth moving equipment, material handler, logging machine, compactor, construction equipment, stationary power generator, pump, aerospace application, locomotive application, marine application, or any other device or application requiring a power system 10.

The power system 10 includes an engine 12 and an aftertreatment system 14 to treat an exhaust stream 16 produced by the engine 12. The engine 12 may include other features not shown, such as controllers, fuel systems, air systems, cooling systems, peripheries, drivetrain components, turbochargers, exhaust gas recirculation systems, etc. The engine 12 may be any type of engine (internal combustion, gas, diesel, gaseous fuel, natural gas, propane, etc.), may be of any size, with any number of cylinders, any type of combustion chamber (cylindrical, rotary spark ignition, compression ignition, 4-stroke and 2-stroke, etc.), and in any configuration (“V,” in-line, radial, etc.).

The aftertreatment system 14 includes an exhaust conduit 18 for delivering the exhaust stream 16 and a Selective Catalytic Reduction (SCR) system 20. The SCR system 20 includes an SCR catalyst 22, and a reductant supply assembly 24.

In some embodiments, the aftertreatment system 14 may also include a diesel oxidation catalyst (DOC) 26, a diesel particulate filter (DPF) 28, and a clean-up catalyst 30. The DOC 26, DPF 28, SCR catalyst 22, and clean-up catalyst 30 may include the appropriate catalyst or other material, respective of their intended functions, disposed on a substrate. The substrate may consist of cordierite, silicon carbide, other ceramic, a metal structure or other configurations of similar materials. In one embodiment, the substrates may form a honeycomb structure with a plurality of longitudinal channels or cells for the exhaust stream 16 to pass through. The DOC 26, DPF 28, SCR catalyst 22, and clean-up catalyst 30 substrates may be housed in canisters, as shown, or may be integrated into the exhaust conduit 18. The DOC 26 and DPF 28 may be in the same canister, as shown, or may be separately disposed. Similarly, the SCR catalyst 22 and clean-up catalyst 30 may also be in the same canister, as shown, or may be separately disposed.

The aftertreatment system 14 is configured to remove, collect, or convert undesired constituents from the exhaust stream 16. The DOC 26 oxidizes carbon monoxide (CO) and unburnt hydrocarbons (HC) into carbon dioxide (CO2) and water (H2O). The DPF 28 collects particulate matter or soot. The SCR catalyst 22 is configured to reduce an amount of nitrous oxides (NOx) in the exhaust stream 16 in the presence of a reductant.

The clean-up catalyst 30 may embody an ammonia oxidation catalyst (AMOX). The clean-up catalyst 30 is configured to capture, store, oxidize, reduce, and/or convert reductant that may slip past or breakthrough the SCR catalyst 22. The clean-up catalyst 30 may also be configured to capture, store, oxidize, reduce, and/or convert other constituents present in the exhaust stream.

In the illustrated embodiment, the exhaust stream 16 is configured to exit the engine 12, pass through the DOC 26 and DPF 28, pass through the SCR catalyst 22, and then pass through the clean-up catalyst 30 via the exhaust conduit 18. In the illustrated exemplary embodiment, the SCR system 20 is downstream of the DPF 28 and the DOC 26 is upstream of the DPF 28. In embodiments where it is included, the clean-up catalyst 30 is downstream of the SCR system 20. In other embodiments, these devices may be arranged in a variety of orders and may be combined together. In one alternative embodiment, the SCR catalyst 22 may be combined with the DPF 28 with the catalyst material for the SCR deposited on the DPF 28. Other exhaust treatment devices may also be located upstream, downstream, or within the SCR system 20.

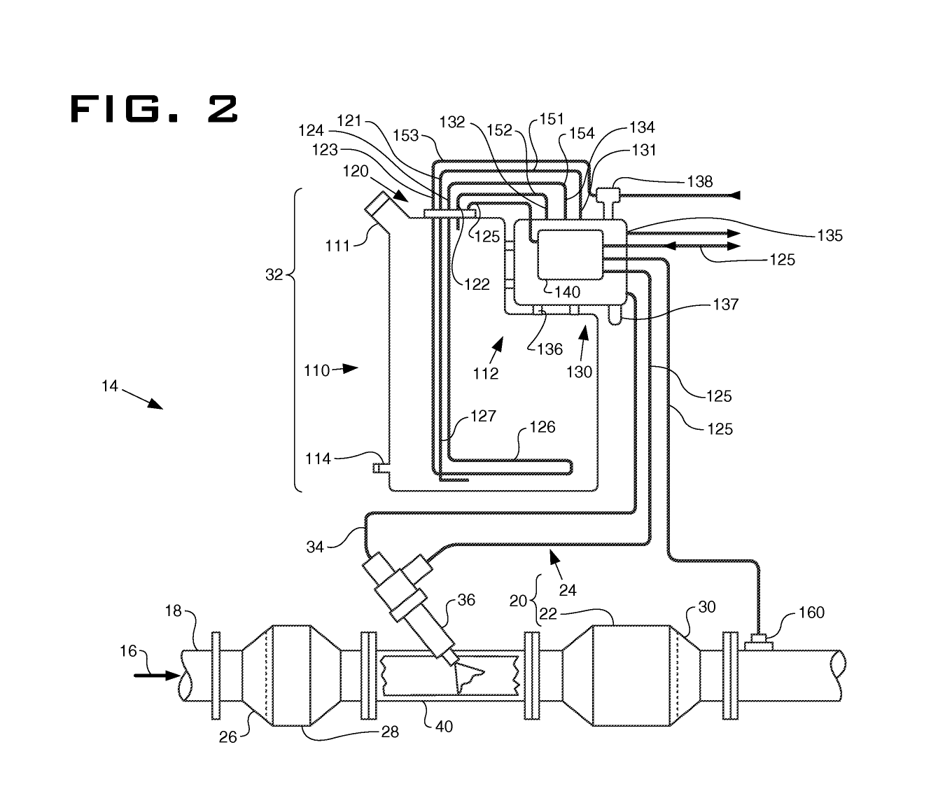

FIG. 2 is a diagrammatic view of the aftertreatment system 14 wherein the reductant supply assembly 24 is configured to introduce the reductant into the exhaust stream 16 upstream of the SCR catalyst 22. The reductant supply assembly 24 may include a reductant supply system 32, which may also be referred to hereinafter as a pump electronics and tank unit (PETU) 32, a reductant line 34, and an injector 36. In the embodiment illustrated in FIGS. 1 and 2, the PETU 32 generally includes a tank 110, a header 120, a pump 130 and associated electronics 140. Embodiments of the PETU 32 will be described in more detail below.

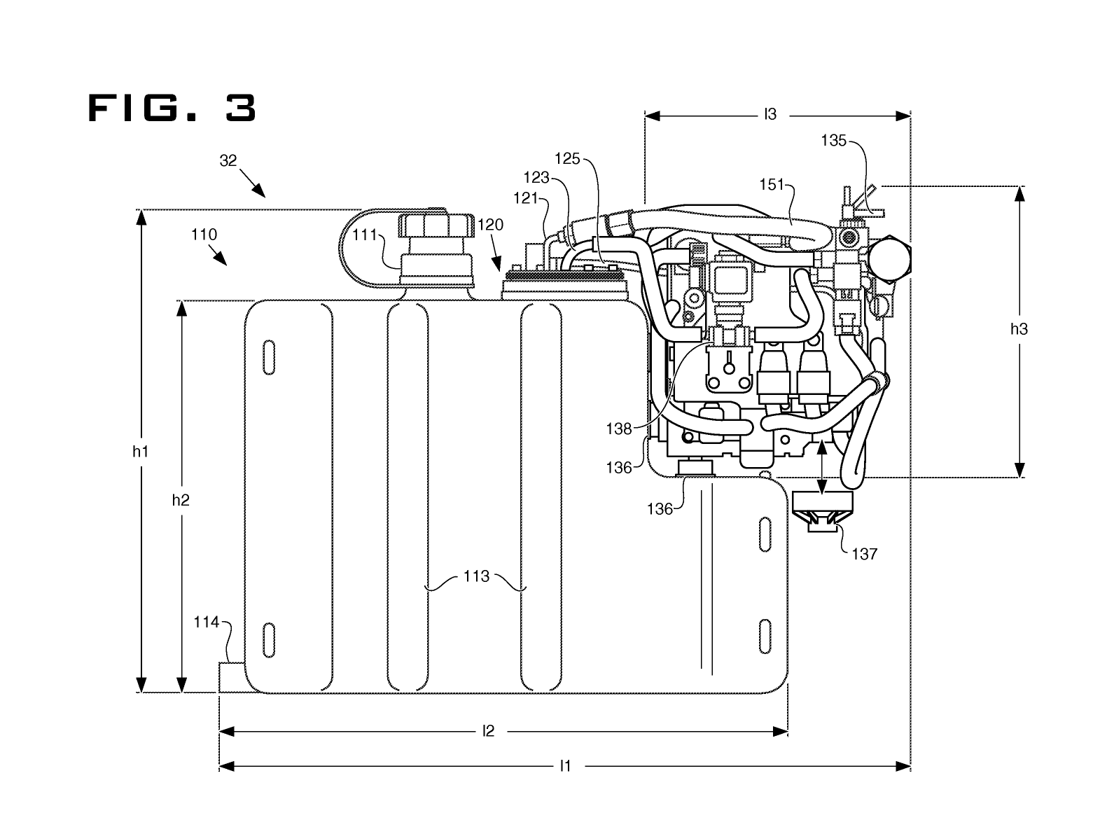

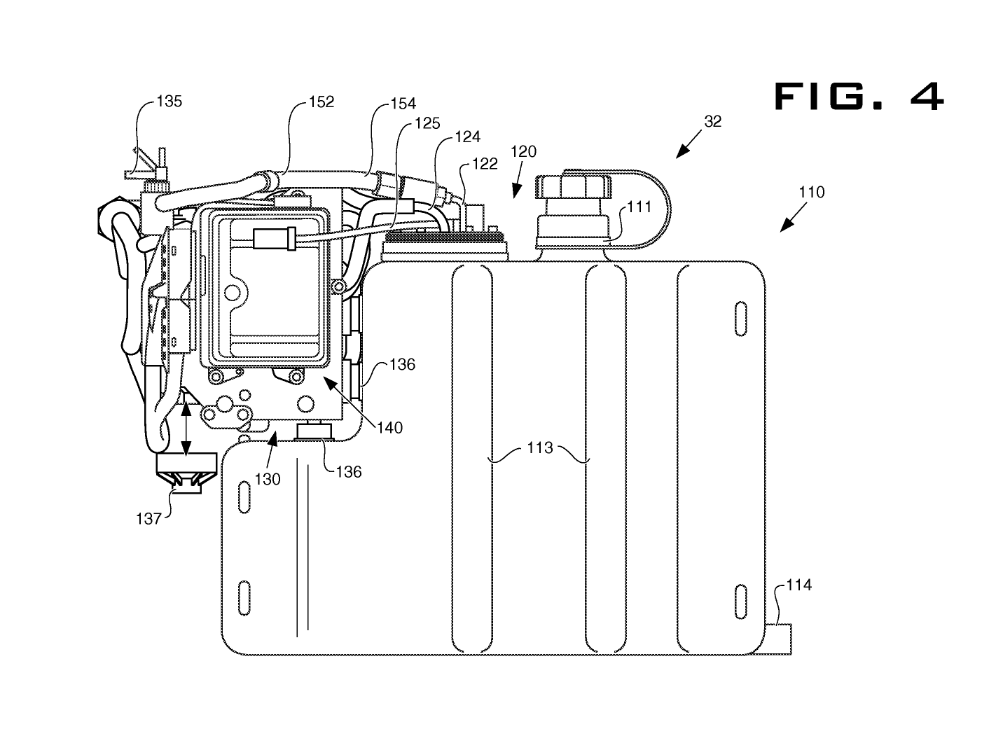

As illustrated in FIGS. 2-5, the tank 110 may include a cap and associated filling passage 111 to introduce reductant into the tank 110. The tank 110 also includes a recess 112. The recess 112 is configured such that the pump 130 is at least partially disposed within the recess 112. Referring in particular to FIGS. 3-5, in at least one embodiment, the tank 110 includes grooves 113 disposed along the tank 110 to provide structural strength thereto. The tank 110 may also be configured to include at least one drain 114 disposed along the bottom thereof in order to easily drain the tank 110, e.g., to drain the tank 110 to remove sludge, to prevent freezing of the reductant within the tank, or to correct a misfilling event.

As illustrated in FIGS. 2-5, the header 120 includes a plurality of ports disposed thereon. According to one exemplary embodiment, the header 120 includes a reductant outlet port 121, a reductant return port 122 for returning reductant to the tank 110 during a purge event, a coolant inlet port 123 and a coolant outlet port 124. In the illustrated embodiment, the header 120 also includes an electrical connection 125 which may be connected to a level sensor (not shown), a temperature sensor (not shown), or various other sensors for detecting conditions within the tank 110. As illustrated in FIG. 2, the header 120 may be connected to a coolant loop 126. The function of the coolant will be described in more detail below. The header 120 may also be connected to a reductant pickup line 127 which extends in proximity to a bottom of the tank 110. Alternative embodiments include configurations wherein one or more of the ports, lines, sensors and/or connections described above may be omitted or wherein additional ports, lines, sensors and/or connections may be added.

As illustrated in FIGS. 2-5, the pump 130 may be connected to the various ports on the header 120. For instance, a reductant supply line 151 may connect the reductant outlet port 121 to a reductant inlet 131 on the pump 130. Similarly, a reductant return line 152 may connect the reductant return port 122 to a reductant outlet 132 on the pump 130. The pump 130 may also include various connections for coolant. In the illustrated embodiment, the pump 130 includes a coolant inlet 134 connected to a coolant supply line 154 in fluid communication with the coolant outlet port 124 on the tank 110. In such an embodiment, the pump 130 receives coolant that has already flowed through the tank 120. The pump 130 may include an internal passage (not shown) in fluid communication with the pump coolant inlet, wherein the internal passage is in thermal communication with a chamber of the pump which contains reductant. Thus, the internal passage of the pump 130 may be heated such that any reductant contained in the pump 130 may be thawed by the coolant. In the illustrated embodiment, the pump 130 includes a coolant outlet 135 for flowing coolant back to the engine 12. However, such a configuration is only one exemplary embodiment, and alternative configurations are within the scope of this disclosure.

As illustrated in FIGS. 2-5, the pump 130 is disposed at least partially within the recess 112 of the tank 110. That is, the pump 130 is mounted such that it is bounded on two sides, e.g., a horizontal and vertical side, by edges of the recess 112. In one embodiment, the pump 130 is mounted to the tank 110 via at least one fastener assembly 136. In one exemplary embodiment the fastener assembly 136 may include a boss and a means for securing the pump 130 to the boss. According to one exemplary embodiment, the fastener assembly 136 may be spun-welded to the tank 110, thus reducing a number of through holes in the tank 110. A support structure of the pump 130 then connects to the fastener assembly 136. In the present exemplary embodiment, the pump 130 is illustrated as being directly connected to the at least one fastener assembly 136, and thus the pump 130 is mounted directly to the tank 110 via the fastener assembly 136. Alternative embodiments include configurations wherein the pump 130 may be disposed on a bracket (not shown) which is mounted to the fastener assembly 136, and thus the bracket may be the support structure of the pump 130.

The pump 130 may further include a filter 137. The filter 137 may be disposed such that it may be easily removed from the pump 130 in a substantially downward direction parallel with a height of the tank 110. According to various alternative embodiments, the filter 137 may be disposed separately from the pump in a separate housing; however, even in such an alternative embodiment, the filter 137 is in fluid communication with the pump 130.

A coolant flow valve 138 may be connected to the pump 130 or, in an alternative embodiment, on a bracket (not shown) coupled to the tank 110, e.g., the bracket (not shown) on which the pump 130 may alternatively be mounted. The coolant flow valve 138 may control a flow of coolant from the engine 12 to the tank 110 through a coolant inlet line 153. In at least one embodiment, the coolant flow valve 138 includes an electronic control capability as discussed below.

As illustrated in FIGS. 2-5, the electronics unit 140 may be disposed adjacent to the pump 130. In one embodiment, the electronics unit 140 may be mounted directly to the pump 130, although alternative embodiments include configurations wherein the electronics unit 140 is connected to the bracket (not shown) on which the pump 130 is mounted for connection to the tank 110. According to one exemplary embodiment, the electronics unit 140 supplies control signals to the pump 130, injector 36 and coolant flow valve 138. In the present embodiment, the electronics unit 140 receives signals from a level sensor (not shown) and a temperature sensor (not shown) from the tank 110 and relays those signals to an independent electronics unit (not shown), such as an electronics control unit associated with the main power system 10. The electronics unit 140 may also receive signals from at least one NOx sensor 160 and relay signals from that at least one NOx sensor 160 to the independent electronics unit. The electronics unit 140, or the independent electronics unit, may use the NOx sensor 160, or engine maps, or both to control the introduction of reductant from the reductant supply system 24 to achieve the desired level of NOx reduction while controlling reductant slip through the clean-up catalyst 30.

Alternative embodiments include configurations wherein the electronics unit 140 is omitted from the PETU 32 and disposed in an alternative location, e.g., separate from the tank 110, header 120 and pump 130. According to one exemplary embodiment, the electronics unit 140 is omitted altogether; in such an alternative embodiment, electronic control signals may alternatively be sent from, and received by, the independent electronics unit. In such an alternative exemplary embodiment, signals from the level sensor (not shown), the temperature sensor (not shown), soot sensors (not shown) and NOx sensor 160 may be sent directly to the independent electronics unit. Combinations of the two configurations are also possible within the scope of this disclosure.

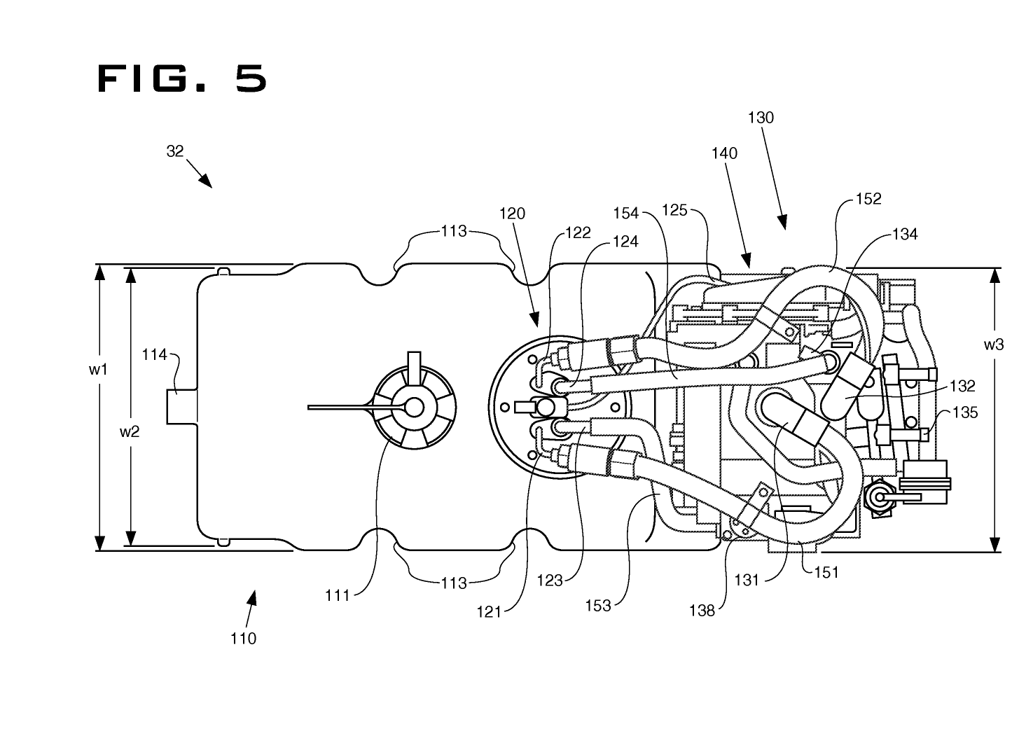

As shown in FIGS. 3 and 5, the PETU 32 has a height h1, a length h1 and a width w1. The tank 110 has a height h2, a length l2 and a width w2. The pump 130 has a height h3, a length l3 and a width w3. As particularly shown in FIG. 5, the pump 130 is disposed such that a width of the header 120, pump 130 and the electronics unit 140 is substantially equal to the width w1 of the tank 110. Also, as shown in FIGS. 3-5, the height h1 of the PETU 32 is less than a combined height of the tank 110 and the pump 130 (h1<h2+h3); a length l1 of the PETU is less than a combined length of the tank 110 and pump 130 (l1<l2+l3). As shown in FIG. 3, the height direction corresponds to a gravitation field direction, e.g., the height of the tank 110 is the direction in which fluid fills the tank 110. Advantages of such a configuration are discussed in detail below.

The injector 36 injects reductant in a mixing section 40 of the exhaust conduit 18 where the reductant may be mixed with the exhaust stream 16. A mixer (not shown) may also be included in the mixing section 40 to assist the mixing of reductant with the exhaust stream 16. While other reductants are possible, urea is the most common reductant.

A heat source (not shown) may also be included to remove soot from the DPF 28 in a process referred to as regeneration. The heat source may also thermally manage the SCR catalyst 22, DOC 26, or clean-up catalyst 30, to remove sulfur from the DOC 26, DPF 28, SCR catalyst 22 or clean-up catalyst 30, or to remove deposits of reductant that may have formed in any of those components or along the exhaust conduit 18. The heat source may embody a burner, hydrocarbon dosing system to create an exothermic reaction on the DOC 26, electric heating element, microwave device, or other heat source. The heat could also be applied by operating the engine 12 under conditions to generate elevated exhaust stream 16 temperatures. A backpressure valve or another restriction in the exhaust conduit 18 could also be used to cause elevated exhaust stream 16 temperatures.

### INDUSTRIAL APPLICABILITY

Prior art SCR systems utilize reductant supply systems that locate the tank separately a distance away from the pump. The pump and tank are then connected via relatively long lines for transporting the reductant from one to another. This leads to increased risk of line freezing due to failure to remove all reductant from the lines when the machine is shut down. Such a configuration also leads to difficulties with packaging as separate spaces must be found for the pump and tank. The tanks used in the prior art SCR systems also are typically of a size and shape such that even if a pump were to be mounted to the tank, such a combined unit would have at least one dimension that was equal to the sum of the extension of the pump in that dimension and the extension of the tank in that dimension, e.g., the combined height would be equal to the height of the pump plus the height of the tank. Such a configuration also leads to difficulties with packaging. The present disclosure is presented to alleviate such difficulties.

Referring again to FIGS. 1 and 2, in operation, the power system 10 generates the exhaust stream 16. The exhaust stream flows along the exhaust conduit 18 and is received by the DOC 26, when included, and the DPF 28. The DOC 26 and DPF 28 modify the exhaust stream 16 to remove particulate matter and oxidizes carbon monoxide (CO) and unburnt hydrocarbons (HC) into carbon dioxide (CO2) and water (H2O) as discussed above.

The modified exhaust stream 16 then flows downstream to be treated by the SCR system 20. The injector 36 injects a reductant into the exhaust stream 18 upstream of the SCR catalyst 22. While other reductants are possible, urea is the most common reductant. The urea reductant converts, decomposes, or hydrolyzes into ammonia (NH3) and is then adsorbed or otherwise stored in the SCR catalyst 22. The NH3 is then consumed in the SCR catalyst 22 through a reduction of NOx into nitrogen gas (N2) and water (H2O).

The injector 36 receives the reductant from the pump 130, which in turn draws the reductant from the header 120 and the tank 110 along the reductant pickup line 127. The reductant may undergo filtering within the tank 110, at the filter 137 and again at the injector 36, among various other filtering locations. According to various alternative embodiments, the filter 137 may be easily removed from along an overhanging portion of the pump 130 rather than necessitating a removal of the pump 130 from its mounting position in order to access the filter 137.

As illustrated in FIGS. 2-5, the PETU 32 includes the tank 110 having sufficient capacity for supplying reductant to the exhaust stream 16 during operation of the power system 10. That is, if the power system 10 typically undergoes a work period of 8 hours between shut-down events, the tank 110 may be sized to provide enough reductant for operation of the power system 10 under typical operating conditions during the 8 hour work period.

As briefly discussed above, the PETU 32 includes a thermal management system utilizing coolant from the engine 12 in order to thaw, or prevent freezing of, the reductant within the tank 110, header 120 and pump 130. In operation, a temperature reading sensed by the temperature sensor in the tank may be sent to the electronics unit 140. A determination about the condition of the reductant contained in the tank 110 may then be made based on the temperature reading and appropriate actions may be taken based on the determination, e.g., if the temperature reading is below a predetermined threshold, the electronics unit 140 initiates a reductant thawing event.

One embodiment of the thawing event may include opening the coolant flow valve 138 to allow coolant from the engine, which has a relatively high temperature compared to the frozen reductant, to flow therethrough, into the header 120 and then through the coolant loop 126 of the tank 110. After flowing through the radiative coolant loop, the coolant then flows back out through the header 120 and into the pump 130. The coolant then transfers thermal energy to the pump 130 before flowing back to the engine 12. Once the temperature reading from the tank 110 is above the predetermined threshold, the electronics unit 140 determines the reductant to be thawed and terminates the thawing event, e.g., by closing the coolant flow valve 138.

According to various alternative embodiments, the reductant lines 34 may be heated by electrical heaters (not shown) or by water jackets (not shown) heated by engine coolant in order to thaw, or prevent freezing of, reductant contained therein.

While one embodiment of a method for thawing the tank 110, header 120 and pump 130 has been described above, the present disclosure is not limited thereto and various other control schemes may alternatively be used to thermally manage the SCR system 20.

By locating the tank 110 and pump 130 adjacent to one another with the pump 130 disposed within a recess 112 of the tank 110, the coolant flow lines, i.e., the coolant inlet line 153 and coolant supply line 154, from the coolant control valve 138 to the header 120 and from the header 120 to the pump 130, may be shortened, thereby reducing the overall number of coolant connections as compared to a system where the pump and tank are separately supplied with coolant.

In contrast to prior art systems wherein the tank 110 and pump 130 are separately mounted, the disclosed system allows for easier packaging and assembly. That is, in the disclosed system, all of the connections related to the reductant supply system 24 are conveniently located in one assembly. The required connections between the tank 110, header 120, pump 130 and electronics unit 140 may be preassembled prior to insertion into a particular application, e.g., a machine.

The disposition of the pump 130 within the recess 112 provides mounting options for providing both vertical and lateral support to the pump 130 in relation to the tank 110. Using two planes of support may be advantageous in a high-vibration environment, such as those produced in association with power system 10. As illustrated in FIGS. 2-5, having multiple planes of support may reduce movement of the pump 130 along a single plane and provides additional support in the event of a fastener assembly 136 failure. However, the recess 112 also provides easy mounting options if the pump 130 were to be mounted to only one side of the recess 112, e.g., the pump 130 may be mounted only to the side of recess 112 or only to the bottom of recess 112 depending upon a desired assembly process.

In one embodiment, the fastener assemblies 136 may be spin-welded to the tank 110, thereby supplying a quick and inexpensive method for providing the fastener assemblies 136 on the tank 110. In addition, such a method reduces the number of orifices in the tank and thereby helps to prevent opportunities for leakage from the tank 110. Such a method also may reduce the total number of parts used in the system, and thus reduces the number of potential failure modes.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A fluid supply assembly comprising:
a tank configured for holding a fluid; and
a pump configured to draw the fluid from the tank,
wherein the tank includes a recess and the pump is mounted to the tank in the recess.

2. The fluid supply assembly of claim 1, further including at least one fastener assembly configured to couple the tank to the pump.

3. The fluid supply assembly of claim 2, wherein the tank is a plastic tank and the at least one fastener is spin welded to the tank.

4. The fluid supply assembly of claim 2, wherein the recess includes a first wall and a second wall disposed substantially perpendicular to the first wall.

5. The fluid supply assembly of claim 4, wherein the at least one fastener assembly includes a first fastener assembly disposed on the first wall and a second fastener assembly disposed on the second wall, and the first fastener assembly and the second fastener assembly provide a positional fixation between the pump and the tank.

6. The fluid supply assembly of claim 1, wherein the pump extends in a first dimension beyond an extension of the tank in the same dimension such that a distal portion of the pump extends beyond the tank, the fluid supply assembly further including a filter disposed in fluid connection with the pump and disposed in the distal portion of the pump.

7. The fluid supply assembly of claim 1 further including:
a header coupled to the tank and including at least a portion thereof which extends into an interior of the tank,
wherein the pump is fluidly coupled to the header.

8. The fluid supply assembly of claim 7, wherein a height of the fluid supply assembly is less than a combined height of the tank and the pump and wherein a length of the fluid supply assembly is less than a combined length of the tank and the pump.

9. The fluid supply assembly of claim 9, wherein a width of the fluid supply assembly is substantially equal to at least one of a width of the tank and a width of the pump.

10. The fluid supply assembly of claim 8, wherein the header further includes a fluid pickup line which extends from the header to substantially a lowest portion of the tank.

11. The fluid supply assembly of claim 8, wherein the header further includes:
a header coolant inlet;
a header coolant outlet; and
a coolant loop extending into the tank and having a first end coupled to the header coolant inlet and a second end coupled to the header coolant outlet.

12. The fluid supply assembly of claim 11 wherein the pump includes:
a pump coolant inlet in fluid communication with the header coolant outlet;
a pump coolant outlet; and
an internal passage in fluid communication with the pump coolant inlet and pump coolant outlet, wherein the internal passage is in thermal communication with a chamber of the pump which contains fluid.

13. The fluid supply assembly of claim 1, wherein the fluid is a reductant configured to react with a selective catalytic reduction (SCR) catalyst.

14. The fluid supply assembly of claim 13, further including:
at least one reductant injector fluidly coupled to the pump.

15. An aftertreatment system comprising:
an exhaust conduit configured to transmit exhaust gases from an engine;
a fluid supply assembly including:
a tank configured for holding a fluid, the tank including a recess therein; and
a pump disposed in the recess and configured to draw the fluid from the tank, wherein the pump is supported on two separate sides by the recess; and
an injector fluidly coupled to the pump, the injector being coupled to the exhaust conduit and configured to inject the fluid into the exhaust gases;
an SCR catalyst coupled to the exhaust conduit and configured to receive the exhaust gases and the fluid.

16. The aftertreatment system of claim 15, wherein a wall thickness in an area where the pump is mounted is predetermined to allow insertion of a fastener assembly without the formation of a through hole.

17. The aftertreatment system of claim 15, wherein the fluid is a reductant configured to react with the SCR catalyst.

18. The aftertreatment system of claim 15, wherein the tank includes at least one rib configured to enhance a bending strength of a wall of the tank.

19. A method of manufacturing a fluid supply assembly comprising:
providing a tank configured to hold a fluid, the tank having a recess;
mounting a pump to the tank in the recess; and
fluidly coupling the pump to the fluid within the tank via a header.

20. The method of claim 19, wherein the fluid supply assembly is assembled prior to connection to an exhaust system.
